(19) United States
(12) Patent Application Publication
(10) Pub. No.: US 2026/0236551 A1
(43) Pub. Date: Aug. 13, 2026

(54) METHOD FOR MANAGING DATA ASSOCIATED WITH A TIMEPIECE

(71) Applicant: ROLEX SA, Geneva (CH)

(72) Inventors: Thomas Hofer, Carouge (CH); Damien Mimoun, Collonges-sous-Salève (FR); Mickaël Mortier, Sallanches (FR); Thierry Penet, Annecy (FR); Yann Souchon, Soral (CH)

(73) Assignee: ROLEX SA, Geneva (CH)

(21) Appl. No.: 19/150,213

(22) PCT Filed: Jan. 30, 2024
(86) PCT No.: PCT/EP2024/052276

§ 371 Date: Jul. 23, 2025

(30) Foreign Application Priority Data
Jan. 30, 2023 (EP) 23153987.5

(51) Int. Cl. G06F 16/958; G06F 21/31

(52) U.S. Cl. CPC G06F 16/958; G06F 21/31

(57) ABSTRACT

A method for managing data associated with a timepiece (10) belonging to a user, the data including data of a first type (51) including personal data of the user or consisting of personal data of the user, and data of a second type (61) including data specific to the timepiece or consisting of data specific to the timepiece, the method including a first exclusive mode (S10) in which the data of the first type (51) can be consulted by the user, and a second exclusive mode (S20) in which the data of the first type (51) cannot be consulted by the user, the data being capable of being consulted via a web page (71).

### FIELD OF THE INVENTION

The invention relates to a method for managing data associated with a timepiece belonging to a user. The invention also relates to a data management system implementing such a method. The invention further relates to a computer program implementing such a method. The invention additionally relates to a recording medium on which such a program is recorded. The invention finally relates to a signal from a data carrier, carrying the computer program product.

### BACKGROUND ART

When a user hands over a watch to a retailer for servicing (after-sales servicing), it is essential that the user is able to communicate with the retailer in order, in particular, to agree on estimates and/or actions to be carried out on the watch. This communication is generally conducted via emails, fax or phone calls. These communication means are now substantially outdated when compared with the possibilities offered by the new technologies, and can only offer a relatively limited customer experience. Furthermore, these communication means are either not secured or only poorly secured. In particular, these means cannot reliably ensure that communications are actually exchanged with the real user of the watch. As a result, protection of the user's personal data may be compromised.

Today, solutions in the watchmaking sector make it possible to display, on a terminal, specific data about a watch or a set of characteristics of a watch by implementing a unique means of access using a card in an identity card format in accordance with the ISO 7810 ID-1 standard.

“Watch Certificate” proposes a card intended to prove the authenticity of a watch. This card can be used to access different specific data of a watch via a web page, by scanning a QR code present on the card, for example with a smartphone. Furthermore, various personal data can also be accessed, in particular data relating to the owner of the watch, by entering a code written on the card. This solution uses blockchain technology to ensure a very high level of traceability of specific and personal data.

A solution of the same type using blockchain technology by the “Arianee” consortium is used by other watchmakers. This solution provides full traceability and is designed to prove the authenticity and ownership of a watch. The solution put forward is also a card linked to a watch and provided with a QR code. It could alternatively be provided with an NFC (Near Field Communication) chip. Once scanned with a smartphone, the card allows the user to access a web page in order register the user's watch and obtain a certificate of authenticity. In order to obtain this certificate, the user is invited to connect to a dedicated mobile application in order to generate a certificate in NFT (Non-Fungible Token) format and declare himself or herself as the first owner.

The Omega watch brand proposes a solution that can be used to access specific data of a watch using a card provided with an NFC chip. Access to this data requires a user account and a dedicated application on a smartphone compatible with NFC technology.

Some watch brands use solutions proposed by the company “WISeKey” which, in particular, uses blockchain technology to offer warranty and/or authentication cards for watches, and even payment functions linked to the watch.

It should be noted that the very high level of traceability offered by blockchain technology involves unalterable storage of all historical data and, depending on the strategy adopted, of the personal data of the different owner or owners of the watch.

Moreover, in the known solutions, it is necessary to download an application dedicated to the solution, create a user account and use an identifier. These operations are inconvenient for users and are susceptible to security breaches.

### SUMMARY OF THE INVENTION

The aim of the invention is to provide a method for managing data associated with a timepiece belonging to a user which overcomes the disadvantages mentioned above and improves on the management methods known from the prior art. In particular, the invention makes it possible to implement a method that enables easy communication between a user and a third party (database manager and/or retailer and/or organisation responsible for after-sales servicing) without compromising the security of the user's personal data.

A management method according to the invention is defined by point 1 below.
1. A method for managing data associated with a timepiece belonging to a user, the data comprising:
   data of a first type including personal data of the user or consisting of personal data of the user, and
   data of a second type including data specific to the timepiece or consisting of data specific to the timepiece,
the method comprising the following exclusive modes:
   a first mode in which the data of the first type can be consulted by the user, and
   a second mode in which the data of the first type cannot be consulted by the user,
the data being capable of being consulted via a web page.

Different embodiments of the method are defined by points 2 to 11 below.
2. The management method according to the preceding point, wherein, in the first mode or in the second mode, the data of the second type can be consulted by the user.
3. The management method according to one of the preceding points, wherein the transition from the first mode to the second mode is performed by one of the following events:
   an action by a data manager,
   an action by the user,
   the expiry of a timeout.
4. The management method according to one of the preceding points, wherein the transition from the second mode to the first mode is performed by an action by a data manager.
5. The management method according to one of the preceding points, wherein the data of the first type can be consulted by the user subject to strong authentication of the user or multi-factor authentication of the user, in particular authentication using a code sent to the user and enabling connection to the web page.
6. The management method according to one of the preceding points, wherein the data of the first type or of the second type can be consulted by the user subject to authentication of an access means, in particular an NFC access means, by an authentication means.
7. The management method according to the preceding point, wherein the access means is associated with at least one specific item of data of the timepiece and/or the access means is provided with cryptographic functions enabling a new URL to a new web page to be generated at each use.
8. The management method according to one of the preceding points, wherein, in the first and second modes, the data of the second type can be consulted anonymously by the user, without user authentication.
9. The management method according to one of the preceding points, wherein the first mode enables secure communication between the user and another authenticated person, in particular the manager.
10. The management method according to one of the preceding points, wherein the method is implemented using a terminal of the smartphone or tablet or computer type on which only the applications integrated as standard in the terminal are required and/or it is not necessary to install any specific application and/or no user account needs to be used and/or no user account identifier needs to be used.
11. The management method according to one of the preceding points, wherein at least one item of data of the first type is associated with at least one item of data of the second type when switching from the second mode to the first mode and wherein the data of the first type and the data of the second type are dissociated when switching from the first mode to the second mode.

A management system according to the invention is defined by point 12 below.
12. A system for managing data associated with a timepiece belonging to a user, the system comprising means for implementing the method according to one of the preceding points.

Embodiments of the system are defined by points 13 and 14 below.
13. The system according to the preceding point, wherein the system comprises an NFC access means.
14. The system according to the preceding point, wherein the system comprises a means capable of communicating with the access means or reading the access means.

A program product according to the invention is defined by point 15 below.
15. A computer program product that can be downloaded from a communication network and/or recorded on a computer-readable and/or computer-executable data carrier, wherein it comprises instructions which, when the program is executed by the computer, cause it to implement the method according to any one of points 1 to 11.

A recording medium according to the invention is defined by point 16 below.
16. A computer-readable recording medium comprising instructions which, when executed by a computer, cause it to implement the method according to any one of points 1 to 11.

A data carrier signal according to the invention is defined by point 17 below.
17. A signal from a data carrier, carrying the computer program product according to point 15.

### BRIEF DESCRIPTION OF THE DRAWINGS

The appended drawing shows, by way of example, an embodiment of a management method according to the invention and an embodiment of a data management system.

FIG. 1 is a schematic representation of an embodiment of a data management system.

FIG. 2 is a flow chart of a first procedure of an embodiment of a data management method.

FIG. 3 is a flow chart of a second procedure of the embodiment of the data management method.

### DETAILED DESCRIPTION OF PARTICULAR EMBODIMENTS

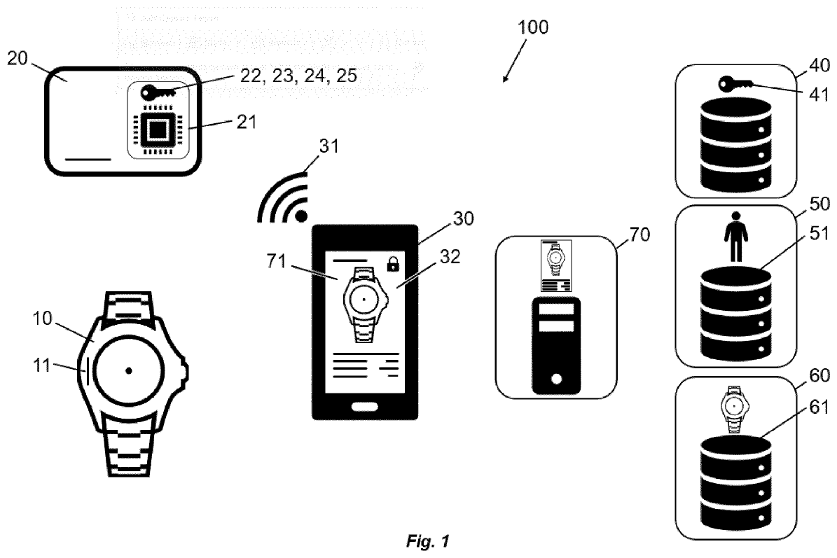

An embodiment of a data management system 100 is described below in reference to FIG. 1. The system 100 can be used to manage data relating to a watch product 10, for example a timepiece or a watch, in particular a wristwatch. The watch product 10 comprises, for example, a unique identifier 11 such as a serial number 11. The unique identifier is, for example, a string of alphanumeric characters comprising, for instance, 8 random digits. The unique identifier may be printed with a font that allows for its automatic reading by an optical means. The unique identifier may be engraved on the timepiece product 10, in particular:
on a watch movement, for example, on a mainplate, and/or
on a watch case, for example, on a middle or a flange, and/or
on a wristlet, for example, on a clasp.

The managed data relate not only to the watch product 10 but also, preferably, to:
data relating to the current user (or indeed to previous users), in particular all or part of the following data: the user's names, their postal addresses, their email addresses, their phone numbers, and/or
data relating to the organisation responsible for after-sales servicing (for example a retailer), in particular all or part of the following data: the organization's name, its postal address, its email address, its phone number, and/or
data relating to the watch manufacturer or to the watch company marketing the watch product, in particular all or part of the following data: the name of the watch manufacturer or watch company, its postal address, its email address, its phone number.

The data management system 100 comprises:
a physical medium 20, for example a card 20 in a format defined by the ISO 7810 ID-1 standard, provided with an access means 21 such as an NFC chip 21,
a device or terminal or client 30, for example a computer (which may or may not be portable), a smartphone or a tablet, provided with:
   a web browser application 32 suitable for managing the display of web pages and more generally for ensuring communication with the Internet, and
   a function or a means 31 capable of communicating with the access means 21 or reading the access means 21, such as an NFC function 31 or an NFC means 31,
an authentication means 40 for verifying the authenticity of the access means 21,
a first database 50, for example a relational database, comprising, in particular, data of a first type 51, in particular personal data 51 of the user, and possibly of several users, and
a second database 60, for example a relational database, comprising, in particular, data of a second type 61, in particular data 61 specific to the watch product 10, or indeed to several watch products 10, such as one or more unique identifiers 11,
a server 70, for example a web server or an application server.

The web browser application 32 or “web browser” is preferably an application integrated as standard in the terminal 30. In other words, the web browser 32 is an application that is pre-installed and/or developed by the manufacturer of the terminal 30. The means 31 capable of communicating with or reading the access means 21 is preferably a function integrated as standard in the terminal 30, in particular a radio wave communication function.

The card 20, or more particularly the NFC chip 21, is intended to be associated with at least one specific item of data 61 of the watch product 10, such as the serial number 11.

The NFC chip 21 is designed to be activated by the NFC function 31 of the terminal 30 when the card 20 is brought close to the latter. This action of bringing the card close to the terminal and activation is referred to as a “tap” throughout this document.

The NFC chip 21 is preferably provided with means to ensure, at the time of manufacture, the highest possible level of security. For this purpose, the NFC chip 21 advantageously comprises a unique number 22, cryptographic functions, at least one encryption key 24, like a string of characters, and a means for generating URL internet addresses 25. These cryptographic functions advantageously make it possible to generate encrypted parameters 23 by means of dynamic and/or static variables that are intended to be sent to the authentication means 40, from the terminal 30, via the server 70, in order to verify the encrypted parameters and authenticate the NFC chip 21 during each tap.

In order to be able to decrypt said encrypted parameters 23, the authentication means 40 comprises, in particular, at least one decryption key 41 compatible with the encryption key 24 of the NFC chip 21.

The NFC chip 21 preferably does not require a power cell or battery. It is powered by electromagnetic induction generated by the terminal 30 during the tap.

Each tap of the card 20 is designed to initiate a procedure for connecting to a web page 71 dedicated to the associated watch product 10. On this web page, data contained in the first database 50 and in the second database 60 may be displayed. The data associated with the watch product 10 belonging to a user comprise:
data of a first type 51, for example stored in the first database 50, and
data of a second type 61, for example stored in the second database 60.

The system 100 comprises all of the hardware and/or software means for implementing the management method that is the object of the invention. These means may comprise software means. Preferably, the means form a distributed computing architecture, the means being located in different computers, machines or physical entities.

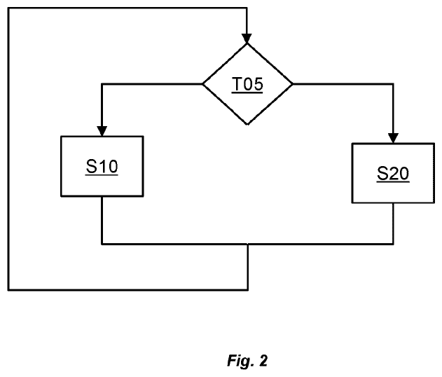

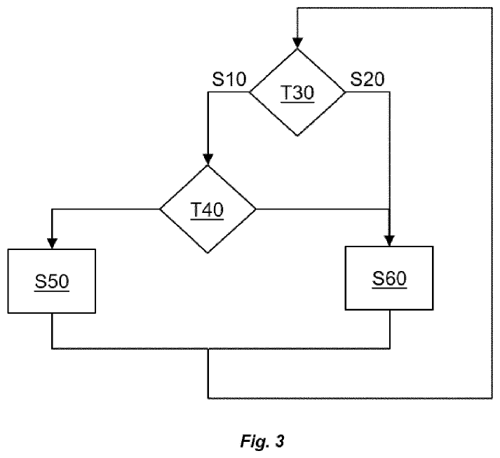

An embodiment of a method for managing data associated with a timepiece belonging to a user is described below in reference to FIGS. 2 and 3. The embodiment is advantageously implemented by the management system described above. The management method may therefore also be considered to be a method for operating a management system described above.

The method comprises the following exclusive modes:
a first mode S10 in which the data of the first type 51 can be consulted, for example on a smartphone, tablet, or computer and/or through a website or application, by the user in a step S50, and
a second mode S20 in which the data of the first type 51 cannot be consulted by the user in a step S60.

The two modes are exclusive, i.e., the method and the system 100 that implements it are:
either in the first mode S10,
or in the second mode S20.

In the first mode S10, the data of the first type 51 can advantageously be consulted by the user via use of the terminal 30 and via the server 70.

The two modes help provide the user with a different experience:
Advantageously, in the first mode S10 (also referred to hereinafter as the “Service” mode), the physical medium 20 allows the user to consult, on a web page 71, the data 61 specific to the watch product 10 associated with the physical medium 20. In other words, it can be used to access the identity file or individual data of said watch product. In this first mode, the physical medium 20 allows the user to access personal data 51 such as an estimate for servicing the watch product 10 or notifications issued by an organisation servicing the watch product 10. Moreover, in this first mode, the user advantageously has the possibility of interacting with the organisation via a dedicated interface on said web page 71. This interaction is advantageously secured.
In the second mode S20 (also referred to hereinafter as the “Anonymous” mode), no data of the first type 51, in particular no personal data of the user, can be accessed. Indeed, the physical medium 20 only allows the user to consult specific data 61 of the watch product 10 associated with the physical medium 20, such as the identity file or the individual data of the watch product, on a dedicated web page 71.

The mode of the management method or the operating mode of the management system (first mode S10 or second mode S20) is defined as a function of the association or dissociation of the watch product 10 with the user, in particular an association or dissociation:
of the data of the first type 51, for example stored in the first database 50, and
of the data of the second type 61, for example stored in the second database 60.

For example, the data is associated/dissociated through an action (such as an entry) performed by a data manager (an organization responsible for an after-sales service operation or a retailer, for instance) via a computer program or application provided to them.

For example, the association of the data or databases is only envisaged if the watch product 10 is handed over to an organisation, for maintenance, for example. In this case, the management system is configured in the first “Service” mode. Otherwise, the management system is configured in the second “Anonymous” mode.

Advantageously, it is possible to modify the mode indefinitely depending on whether or not the user has the watch product 10 in his or her possession.

More generally:
in the first “Service” mode, the terminal 30 allows data contained in the first database 50 to be displayed, even if the first and second databases are not associated, and
in the second “Anonymous” mode, the terminal 30 does not allow data contained in the first database 50 to be displayed or consulted, even if the first and second databases are associated.

In the first “Service” mode, when the user brings his or her watch product 10 to an organisation, such as a retailer, for example for servicing, personal data 51 of the user is recorded or modified in the first database 50. Personal data 51 such as the name, postal address, email address and telephone number of the user may, for example, be recorded in the database 50. This personal data 51 is, in particular, necessary in order to draw up estimates and invoices and communicate with the user. This personal data may be recorded or modified at the time when the user hands over his or her watch product. Alternatively, the personal data 51 may already be contained in the first database 50 at the time when the user hands over his or her watch product 10. Naturally, this first database 50 is not accessible to third parties and uses security methods to optimally protect the personal data 51 of users. The security methods may include access management and/or authorization management and/or encryption and/or network segmentation and/or filtering. Moreover, this data is processed in particular in such a way as to comply with the General Data Protection Regulation or GDPR in Europe, for example.

A physical medium 20, such as a card 20, associated with the watch product 10, is provided to the user in order to enable him or her to connect to the web page 71 dedicated to the watch product 10 via a terminal 30 of the user's choice allowing access to the server 70 via an Internet Protocol. However, preferably, in order for the user to be able to connect to the web page 71, according to the first “Service” mode, it is necessary for at least one of the items of personal data 51 of the user to be associated with a specific item of data 61 of the watch product 10. For example, the telephone number of the user may be associated with the serial number 11 of the watch product 10. The association is preferably made automatically by a computer system providing the interface between the personal data 51 of users and the specific data 61 of watch products, i.e., between:
data from the first database 50, and
data from the second database 60.

However, the transition (from the second “Anonymous” mode S20) to the first “Service” mode S10 is triggered or performed by a first event caused by a data manager (organisation or retailer, for example). This first event may, for example, be a validation or an action on a computer system in use in the organisation to which the user is handing over his or her watch product. Preferably, the first “Service” mode is only active or capable of being activated when the user's watch product 10 has been handed over to the organisation.

In the second “Anonymous” mode, when the user has the watch product 10 in his or her possession, preferably, no association between the personal data 51 of the user and the specific data 61 of the watch product 10 is established. However, the user may still use the physical medium 20 associated with the watch product 10, enabling him or her to access the specific data 61 of the watch product 10 on a dedicated web page 71.

The transition (from the first “Service” mode S10) to the second “Anonymous” mode S20 is triggered or performed by a second event. This second event may, for example, be:
an action by the data manager, such as a validation or an action on a computer system in operation in the organisation to which the user is handing over his or her watch product,
an action by the user, such as a particular action on a human-machine interface of the terminal 30 when it is connected to the server 70 in a secure mode allowing the data of the first type 51 to be consulted. This action may, for example, also consist of communication or an interaction with the organisation, such as refusing an estimate.
the expiry of a timeout. For example, it may be defined by default that the first “Service” mode S10 remains activated for a defined number of days, for example 30 days. At the end of this timeout, there is an automatic switch to the second “Anonymous” mode S20, without any specific action being taken by the user or a third party.

Therefore, as shown in FIG. 2, a test step T05 tests whether the most recent event is a first event or a second event. If the most recent event is a first event, there is a transition to the first mode S10. If not, the most recent event is a second event, and there is a transition to the second mode S20.

Once the physical medium 20 is in the user's hand, the user can connect to the server via a web page 71 dedicated to the watch product 10. To do so, it is possible to proceed as follows:
1. The user has a terminal 30, such as a smartphone 30, provided with an NFC function 31, and taps it with the NFC chip 21 of the physical medium 20.
2. At the time of the tap, the NFC chip 21 is activated and provides the terminal 30 with parameters 23 encrypted by the at least one encryption key 24, and generates a URL 25 which points to a server 70. The URL is preferably a new, different and non-reusable URL each time the NFC chip is used or during each tap.
3. The server 70 then relays, in particular, the encrypted parameters 23 to the authentication means 40.
4. Using the at least one decryption key 41, the authentication means 40 proceeds to authenticate the NFC chip 21 by decrypting the encrypted parameters 23, and to decode the unique number 22 of the NFC chip. Furthermore, the authentication of the NFC chip 21 can also be controlled by any other means for further enhancing security.
5. If authentication of the NFC chip 21 is confirmed, the authentication means 40 sends, in particular, the unique number 22 of the NFC chip 21 back to the server 70. If not, the connection procedure is interrupted.
6. Using the unique number 22, the server 70 consults the second database 60 in order to find the serial number 11 of the watch product 10 associated with the NFC chip 21. Then, if the serial number 11 is further associated with an item of personal data 51 of a user, the server 70 generates a session on the web browser 32 of the smartphone 30 with a web page 71 in the first “Service” mode allowing access to data from the first and second databases. If not, a session with a web page 71 in the second “Anonymous” mode is generated.

In other words, as shown in FIG. 3, in a step T30, in the event of an attempt to consult data by using the physical medium 20, a procedure for authenticating the physical medium, in particular the access means 21, is launched, and, if the procedure for authenticating the physical medium is successful, a test is carried out to learn whether the system is in the first mode S10 or in the second mode S20. If the system is in the first mode S10, a strong authentication procedure T40 is launched, i.e., a procedure where the user holding the physical medium is authenticated. If the user authentication procedure is successful, access is gained to the step S50 in which the data of the first type 51 can be consulted. If not (i.e., if the strong authentication procedure fails or if the system is in the second mode S20), access is gained to the step S60 in which the data of the first type 51 cannot be consulted.

Preferably, it is only possible to open one session at a time with the physical medium 20 and, in particular, it is only possible to open one session at a time with the physical medium 20 in the first “Service” mode. However, as long as the physical medium 20 is associated with the watch product 10, it is possible, for example, to open as many sessions as desired indefinitely and in succession.

Irrespective of the mode (“Service” or “Anonymous”), the session is opened on the user's terminal 30 with the web browser 32 of the latter. Advantageously, no additional or dedicated application, and no user account or account identifier, is required in order to consult and display the web page 71.

In the first “Service” mode, it is advantageous to perform strong authentication of the user, such as multi-factor authentication using at least two distinct factors. The authentication may involve biometric data and/or a temporary code and/or a smart card and/or a mobile application. The factors may be:
knowledge-based factors, such as a password, PIN, or answer to a security question,
possession-based factors, such as a security token (hardware or software), smart card, security key, mobile authenticator, SMS, or notification received on a mobile device,
biometric factors, such as a fingerprint, facial recognition, retina scan, iris scan, or voiceprint,
location-based factors, such as a network connection or geographic location.

Indeed, in this first “Service” mode, it is possible to access personal data 51 of the user via the web page 71 displayed on the terminal 30 and via the server 70. For example, in order to do this, the user is invited to enter a code previously sent by the server 70 to an email address or telephone number entered or contained in the first database 50. This code makes it possible to verify that the user who is attempting to connect is indeed the user who has transmitted his or her personal data 51 and who has handed over the watch product 10 to the organisation. Advantageously, a new code is generated for each new session.

The concept of strong authentication is defined as consisting of access verification combining different strategies and comprising several levels. One of the strategies may consist of a test in various forms (smart card, telephone, email, etc.).

If the physical medium 20 is held by another user while the management system is in “Service” mode, this other user advantageously will not be able to access the personal data 51 of the user of the watch product 10, due to this strong authentication. In particular, this other user will not receive the code sent by the server 70 to the email address or to the telephone number of the user of the watch product 10. The strong authentication of the user will therefore fail.

In the second “Anonymous” mode, the session is opened on the user's terminal 30 with the web browser 32 in order to display the web page 71. The session is opened without strong authentication, but following authentication of the access means 21 by the authentication means 40, because no information or personal data of the user is associated or accessible. In this mode, any person who has the physical medium 20 in his or her possession or who is carrying the physical medium 20 can open such a session. Indeed, in such a session, the user can only access specific data 61 of the associated watch product 10, and access to personal data 51 is excluded.

Therefore, preferably, irrespective of the mode (“Service” or “Anonymous”), the session is only opened after the access means 21 has been authenticated by the authentication means 40.

Preferably, irrespective of the mode, if the procedures of connecting and opening a session have been successful, the web page 71 generated on the user's terminal 30 can be used to display, in steps S50 and S60, the data of the second type 61, i.e., specific data 61 of the watch product such as:
the model of the watch product,
photos of the watch product,
the serial number of the watch product,
the warranty expiry date,
performance measurements,
a user manual, etc.

All of this data is advantageously anonymous. It is, in particular, stored in the second database 60. Therefore, in the first mode S10 or in the second mode S20, the data of the second type 61 can preferably be consulted by the user. This data of the second type 61 can, in particular, be consulted without a password or user account.

In the second “Anonymous” mode, it is sufficient to have the physical medium 20 in order to open a session on the browser 32 and consult data located in the second database 60. This mode may be considered to be a mode without user authentication, since the holder of the physical medium 20 is not necessarily known, the medium possibly having been transferred by the user or stolen from the user. The consultation is therefore anonymous.

Furthermore, in the first “Service” mode, the web page 71 may display, after a strong authentication of the user, personal data 51 such as information about the current service, a service history, estimates or invoices. Furthermore, also following a strong authentication, a communication interface may be generated on the web page 71 between the user and the organisation in possession of the watch product 10. Using this communication interface, the organisation can submit estimates to the user, for example. Advantageously, the user can interact with these estimates by totally or partially accepting them or by refusing them. He or she may even leave comments or communicate directly with the organisation by exchanging messages.

Preferably, only the personal data 51 of the user that is strictly necessary can potentially be accessed or consulted on the web page 71.

It should be noted that, in the first “Service” mode, the user may possibly receive a message from the organisation, for example an SMS or an email, inviting him or her to connect in order to consult new notifications on the web page 71. Naturally, a strong authentication is required in order to open a new session on the browser 32 and access these notifications via the terminal 30.

In order to disconnect from the web page 71, i.e., close the session, it is sufficient to close the web browser 32, irrespective of the operating mode of the management system. Preferably, during a short, defined timeout that may last a few minutes or a few dozen minutes, for example, the session of the web page 71 remains accessible to the user without the need to perform a new procedure to connect or open a session. This ensures smooth browsing on the website 71 and avoids any inconvenience to the user caused by untimely disconnection or temporary malfunction of the connection between the terminal and the server.

Advantageously, the same physical medium 20 can alternatively be configured in such a way as to allow a web page 71 to be displayed in the first “Service” mode and in the second “Anonymous” mode.

Since it is associated with a serial number 11 of a watch product 10, and due to the authentication of the access means 21 during a tap, the physical medium 20 may further be used, in the second “Anonymous” mode, as a certificate that to prove the authenticity of the watch product 10, in particular when the latter is being sold or serviced by an organisation. As already mentioned, in the “Anonymous” mode, no personal data or history can be accessed. The physical medium 20 can therefore be transmitted without any particular precautions and without the risk of compromising the protection of the personal data of previous users of the watch product 10.

It should be noted that, in the first “Service” mode S10, the watch product 10 is not normally in the hands of the user, but in the hands of the organisation. As a result, the watch product cannot be sold under these conditions. In order to be sold, the watch product needs to be retrieved by the user, which inevitably results in the card being transferred to the “Anonymous” mode S20.

As an alternative to connection to a terminal provided with a means 31 for communicating or reading the access means 21, the physical medium 20 can also be used to connect to another terminal that does not have a means 31 for communicating or for reading the access means 21.

The procedure may then take place as follows:
1. Firstly, a dedicated web page is opened in the web browser of the other terminal and a specific item of data 61 of the watch product 10 is entered there, such as the serial number 11. The session is then put on standby.
2. In order to unlock the session, the user is required to tap the terminal 30 with the physical medium 20 associated with or corresponding to the serial number 11 previously entered on the other terminal. The terminal 30 then indicates to the user that a session is on standby on another terminal, and requests confirmation to open said session.
3. Once unlocked, the web page on said session comprises the same functions and interfaces or substantially the same functions and interfaces as a web page 71 generated on the web browser of the terminal 30.

As described previously, if the management system is in the first “Service” mode S10, strong or multi-factor authentication is required in order to access the personal data 51.

Alternatively, instead of the session being put on standby at the end of the first step of the above procedure, an association request may be generated. In order to validate the association request, the user is required to tap the terminal 30 with the physical medium 20. On the terminal 30, the user must then enter the information of the association request displayed on the other terminal. Once the association request has been validated, a session is created and the web page 71 is then generated.

Preferably, irrespective of the embodiment, an NFC chip can only be associated with a single watch product serial number. However, it is preferably possible to associate several NFC chips with the same serial number.

Irrespective of the embodiment, the physical medium may comprise, for example, a print or an engraving enabling the user to identify the watch product with which the medium is associated.

Irrespective of the embodiment, the watch product may, in particular, be:
a watch, in particular a wristwatch,
a watch bracelet,
a timepiece movement.

Irrespective of the embodiment, the physical medium 20 may comprise an access means 21 other than an NFC chip. The access means may, in particular, be:
a QR code, for example printed on the physical medium 20, or
a barcode, for example printed on the physical medium 20, or
an RFID tag, for example adhered to the physical medium or embedded in the physical medium.

In the case of a QR code or a barcode, the user simply needs to scan the QR code or the barcode with a terminal, during the connection procedure, instead of performing a tap on the NFC chip 21. However, the QR code or the barcode cannot be authenticated because it cannot benefit from cryptographic functionality such as the generation of dynamic variables enabling optimum security of the connection to the web page dedicated to the watch product. Moreover, unlike an NFC chip, or, more particularly, unlike the NFC chip 21 according to the invention, a QR code or a barcode can be duplicated very easily, for example simply by taking a photo thereof. As an alternative, other types of access means may be used. Moreover, the physical medium may comprise an access means 21 including any combination of the following elements and/or other suitable elements, without limitation:
an NFC chip,
a QR code, or
a barcode, or
an RFID tag.

The physical medium 20 could also be a medium other than a card, such as a sheet of paper, any object or a watch product.

As a variant, the system can also use means like applications and/or technologies that are not integrated as standard in the terminal 30. These means need to be added specifically to the terminal 30 in order to be part of the data management system according to the invention.

The first and second databases may be hosted on separate machines or in the same machine. Naturally, even if the databases are hosted in the same machine, the association procedure remains as previously described: the association between data of a user and data of a product is preferably only established temporarily when the user delivers his or her watch product to the organisation.

The solution according to the invention allows the method to be implemented using a terminal of the smartphone or tablet or computer type on which it is not necessary to install any specific application that might risk compromising the security of the personal data. Indeed:
consulting the web page 71 only requires an application integrated as standard in the terminal 30,
reading or communicating with the NFC means 31 only requires a function integrated as standard in the terminal 30,
more generally, the method only requires applications and functions integrated as standard in the terminal 30.

Moreover, consulting the web page 71 does not require the creation of either a user account or an account identifier that could also compromise the security of the personal data.

Finally, the solution according to the invention does not enable personal data to be tracked or, more particularly, the different owners of the watch to be tracked.

The proposed solutions help optimise the customer experience by taking advantage of advanced functions offered by some mobile terminals, such as a smartphone. Specifically, these solutions enable a user to securely access a web page dedicated to the user's watch on his or her mobile terminal, by means of a unique means of access that can be authenticated and is associated with the watch product. This access means is in the form of an object provided by a retailer or an organisation responsible for an after-sales servicing operation. These solutions offer simplified and improved exchange and communication capabilities while strengthening the protection of the personal data of users.

1. A method for managing data associated with a timepiece belonging to a user, the data comprising:
data of a first type including personal data of the user, and
data of a second type including data specific to the timepiece,
the method comprising the following exclusive modes:
a first mode in which the data of the first type can be consulted by the user, and
a second mode in which the data of the first type cannot be consulted by the user,
the data being capable of being consulted via a web page.

2. The management method according to claim 1, wherein, in the first mode or in the second mode, the data of the second type can be consulted by the user.

3. The management method according to claim 1, wherein a transition from the first mode to the second mode is performed by one of the following events:
an action by a data manager,
an action by the user,
expiry of a timeout.

4. The management method according to claim 1, wherein a transition from the second mode to the first mode is performed by an action by a data manager.

5. The management method according to claim 1, wherein the data of the first type can be consulted by the user subject to strong authentication of the user or multi-factor authentication of the user.

6. The management method according to claim 1, wherein the data of the first type or the data of the second type can be consulted by the user subject to authentication of an access means, by an authentication means.

7. The management method according to claim 6, wherein
the access means is associated with at least one specific item of data of the timepiece, and/or
the access means is provided with cryptographic functions enabling a new URL to a new web page to be generated at each use.

8. The management method according to claim 1, wherein, in the first and second modes, the data of the second type can be consulted anonymously by the user, without user authentication.

9. The management method according to claim 1, wherein the first mode enables secure communication between the user and another authenticated person.

10. The management method according to claim 1, wherein the method is implemented using a terminal which is a smartphone or tablet or computer,
only applications integrated as standard in the terminal are required, and/or
it is not necessary to install any specific application, and/or
no user account needs to be used, and/or
no user account identifier needs to be used.

11. The management method according to claim 1, wherein
at least one item of data of the first type is associated with at least one item of data of the second type when switching from the second mode to the first mode, and
the data of the first type and the data of the second type are dissociated when switching from the first mode to the second mode.

12. A system for managing data associated with a timepiece belonging to a user, the system comprising means for implementing a method for managing data associated with the timepiece belonging to the user, the data comprising:
data of a first type including personal data of the user, and
data of a second type including data specific to the timepiece,
the method comprising the following exclusive modes:
a first mode in which the data of the first type can be consulted by the user, and
a second mode in which the data of the first type cannot be consulted by the user,
the data being capable of being consulted via a web page.

13. The system according to claim 12, wherein the system comprises an NFC access means.

14. The system according to claim 13, wherein the system comprises a means capable of communicating with the access means and/or capable of reading the access means.

15. (canceled)

16. A non-transitory computer-readable recording medium comprising instructions which, when executed by a computer, cause it to implement a method for managing data associated with a timepiece belonging to a user, the data comprising:
data of a first type including personal data of the user, and
data of a second type including data specific to the timepiece,
the method comprising the following exclusive modes:
a first mode in which the data of the first type can be consulted by the user, and
a second mode in which the data of the first type cannot be consulted by the user,
the data being capable of being consulted via a web page.

17. (canceled)

18. The method according to claim 1, wherein
the data of the first type consists of the personal data of the user, and
the data of the second type consists of the data specific to the timepiece.

19. The management method according to claim 5, wherein the strong authentication or the multi-factor authentication uses a code sent to the user and enabling connection to the web page.

20. The management method according to claim 6, wherein the access means is an NFC access means.

21. The management method according to claim 9, wherein the other authenticated person is the manager.

22. The management method according to claim 2, wherein a transition from the first mode to the second mode is performed by one of the following events:
an action by a data manager,
an action by the user,
expiry of a timeout.
